(19) United States
(12) Patent Application Publication
(10) Pub. No.: US 2016/0304373 A1
(43) Pub. Date: Oct. 20, 2016

(54) LOW ENERGY ACID MINE DRAINAGE TREATMENT PROCESS AND SYSTEM

(71) Applicant: MINUS ENGINEERING LTD, Cheltenham, Gloucestershire (GB)

(72) Inventor: Justin Robert DAGLISH, Cheltenham, Gloucestershire (GB)

(73) Assignee: MINUS ENGINEERING LTD, Cheltenham, Gloucestershire (GB)

(21) Appl. No.: 14/903,327

(22) PCT Filed: May 12, 2014
(86) PCT No.: PCT/GB2014/051443

§ 371 Date: Jan. 7, 2016

(30) Foreign Application Priority Data
May 12, 2013 (GB) 1308466.0

(51) Int. Cl. C02F 9/00; C02F 1/52; C02F 3/20; C02F 1/72; C02F 1/78; C02F 3/12; C02F 1/38; C02F 1/66

(52) U.S. Cl. CPC C02F 9/00; C02F 1/38; C02F 1/5245; C02F 1/66; C02F 1/72; C02F 1/78; C02F 3/12; C02F 3/20; C02F 11/125

(57) ABSTRACT

A process for the treatment of minewater or other waste waters integrating existing treatment processes in a modular scaled system wherein the improved treatment system can make use of a positive head of water, either via siphon or conducted flow to displace pumping costs involved in water treatment. The improved process can to be located underground, as it is both modular and intensified, reducing the physical size of the treatment plant and increasing its flexibility. The improved process has a lower capital cost and reduced operating costs.

### FIELD OF INVENTION

The invention integrates existing treatment processes in a modular sealed system and the improved treatment system can make use of a positive head of water, either via siphon or conducted gravity flow.

### BACKGROUND

Contaminated mine water is produced in large volumes by a large number of closed and operating mineral mines. The rate of production is a function of rainfall, local geology and the extent of the mine. If measures are not taken to control the mine water level, water can eventually spill out of the mine polluting local water reserves as metals and other contaminants contained within the mine water are carried into the receiving watercourse. To alleviate this problem, known techniques, described further below, are employed in a new way to treat the mine water removing metals and other contaminants.

There are a number of drawbacks to the existing treatments. Often the highest electrical cost for existing lime based mine water treatment is the power consumed pumping the high volume of water from the mine to the treatment plant inlet located above the mine. Aeration with conventional mixing is the second highest electrical cost and plants have to be located on a large expanse of flat ground at surface with facility for waste disposal. A further limitation of existing processes is that salts such as sulphates (SO₄) are not removed by traditional neutralisation processes.

Similar drawbacks and cost limitations occur for existing municipal and industrial water treatments. Pumping costs are significant and required for water transfer and pressure generation to allow water treatment. Aeration is again often a significant cost predominantly to facilitate biological treatment processes. In these sectors water treatment often requires treatment using a range of complimentary or different unit operations. All of these require water to be pumped through a water treatment plant and in a conventional arrangement are operated according to the flow regime dictated by the pumping apparatus.

The basic system on which this innovation builds is explained in co-pending GB application no GB 1004577.1 and incorporated herein. The improved process can to be located underground, which is not currently feasible; this benefit is available because the improved process is both modular and intensified, reducing the physical size of the treatment plant and increasing its flexibility. The improved process has a lower capital cost and reduced operating costs as electrical consumption for treatment is reduced and sludge wastes are stabilised and retained in mine, significantly reducing waste handling and disposal costs. The process can also make use of latent water heat within the mine to run further improved treatment process which utilises microbes. The benefits summarised of the improved process are that:
1. The process helps solve the water energy nexus. This nexus is that increasing volumes of water require increasing levels of treatment both of these require increasing amounts of energy, supplied conventionally in the form of electricity to drive water transfer and water treatment
2. The modular capital cost of plant is 30-50% lower than conventional fixed structure treatment.
3. The operating cost is up to 50% lower.
4. The plant can be feasibly located ‘in the mine’. This has knock on benefits by minimising volumes of water requiring treatment and is not currently feasible.
5. Sealed system natural head or siphon effect to be utilised as motive force to minimise power requirements and reduce carbon emissions.
6. Sludge waste can be retained in mine in a stabilised form significantly reducing waste generation/disposal costs.
7. Salts such as sulphate to be treated and removed by the process reducing hazard of water for irrigation or receiving water body.
8. Microbes can be used to accelerate the treatment process.
9. The pH of water can be raised step wise so that precipitated metals can be recovered sequentially.
10. The plant is scalable and footprint of the plant is lower.
11. The technology allows third party technologies to be incorporated into the system allowing them to operate with a lower energy and/or carbon footprint than conventionally.
12. The process when applied to municipal water treatment can allow improved digestion efficiency and gas recovery whilst delivering lower operating costs through pumping savings.

In the context of municipal and industrial water treatments, all of the following non-exhaustive list can be included within the process of the present invention to deliver water treatment with a lower external energy consumption:
1. Filtration
2. Ion exchange
3. pH correction
4. Biological treatment such as Rotating biological contactors or Submerged aerated filters
5. Chemical dosing
6. Adsorbents
7. Electrostatic precipitation
8. Coagulation
9. Digestion

### SUMMARY OF THE INVENTION

The solution to this problem is detailed in the improved process described below. The system utilises a sealed modular static head driven process which significantly reduces the energy requirement in pumping to and through the plant by utilising siphoned or a natural head of water and allows optimisation of unit operations contained within the process saving energy and feedstock chemicals.

The sealed nature of the system allows both supply and discharge head to drive the water treatment process.

An improved aeration arrangement significantly reduces the costs involved in aeration and allows for underground use of the prior art modular sealed system.

### DETAILED DESCRIPTION OF THE DRAWINGS

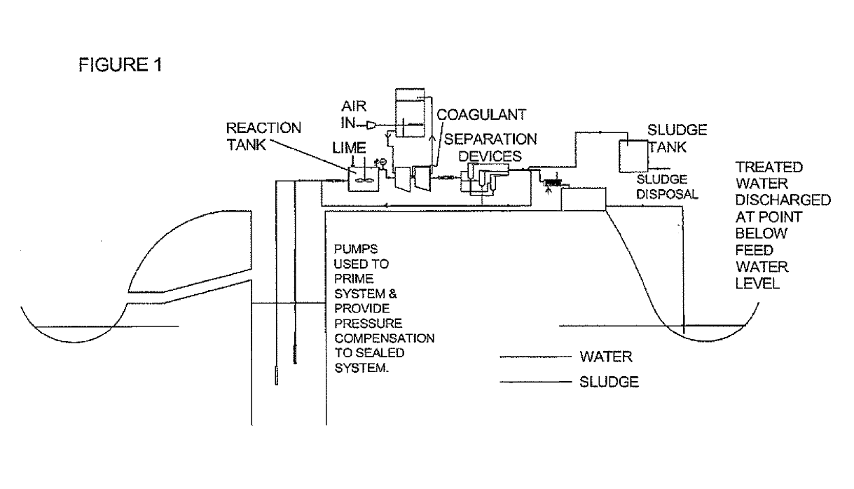

FIG. 1 shows the prior art process;

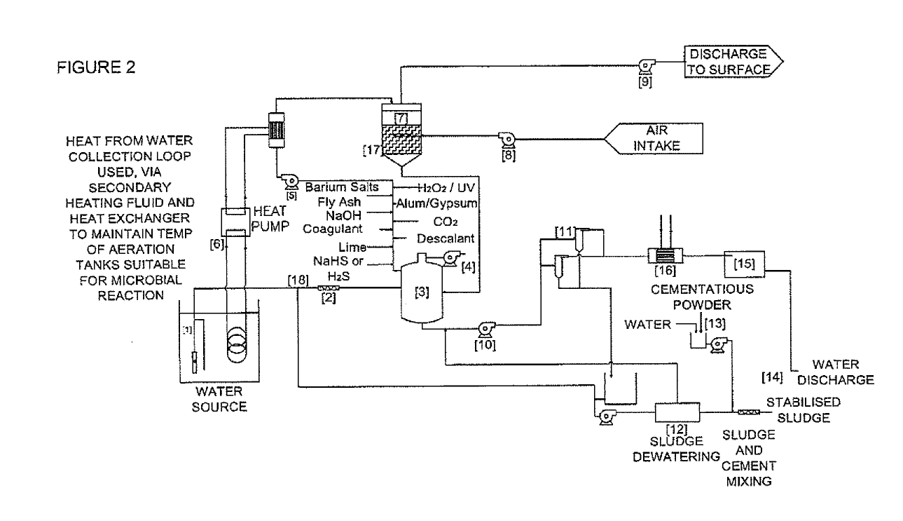

FIG. 2 shows the process of the invention relating to minewater;

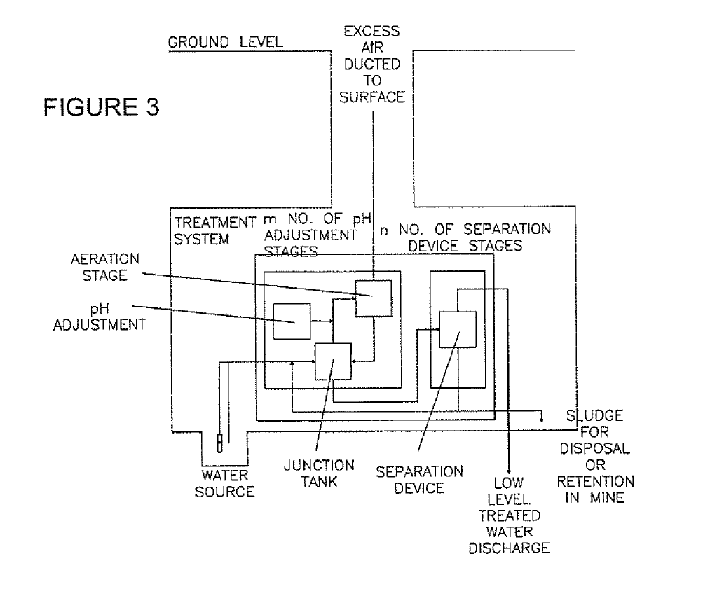

FIG. 3 shows the process of the invention as located in mine;

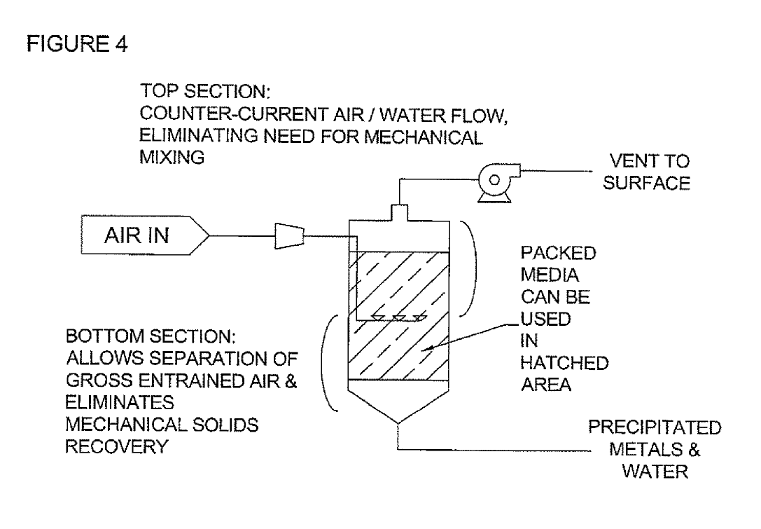

FIG. 4 shows the aeration tank;

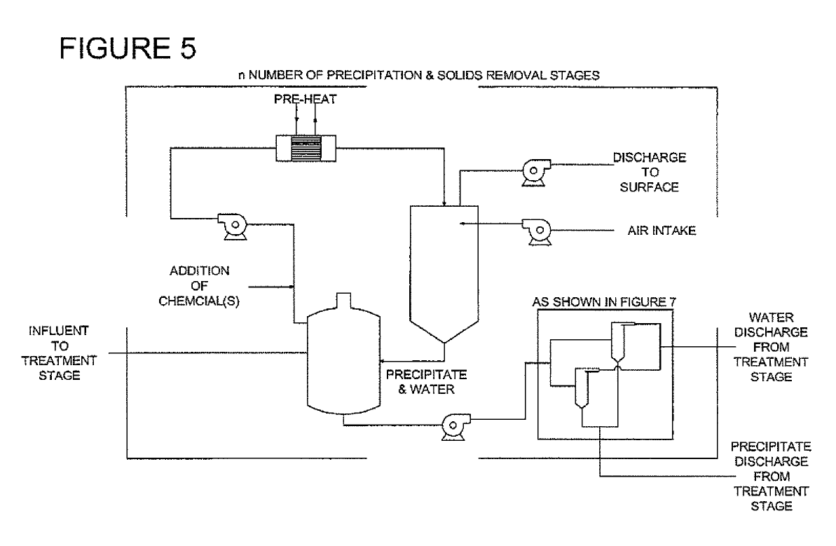

FIG. 5 shows the core repeatable stages of the new process;

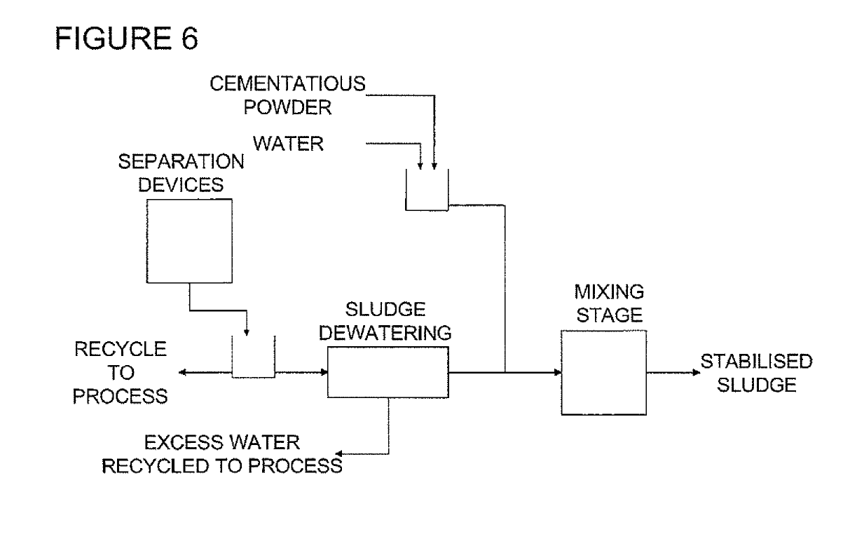

FIG. 6 shows the sludge stabilisation process;

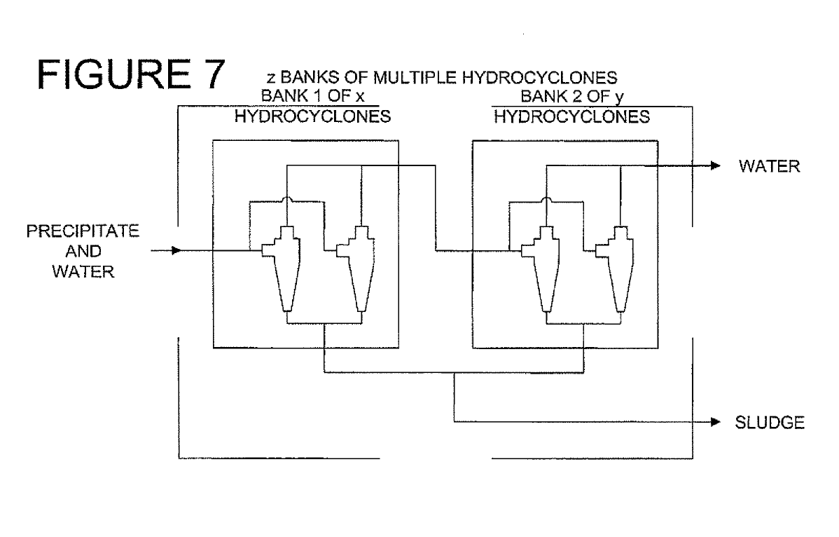

FIG. 7 shows the repeatable hydrocyclone or other separation device stages of the new process;

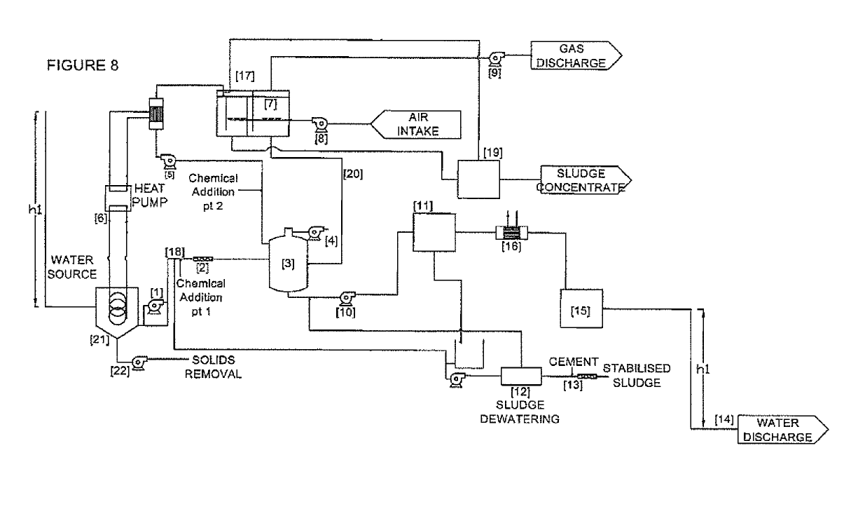

FIG. 8 shows the typical arrangement of the process as applied to municipal or industrial water treatment applications;

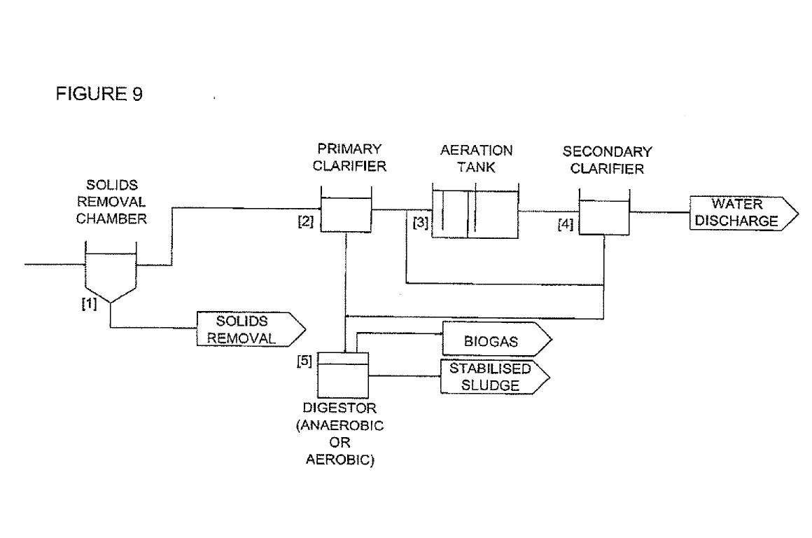

FIG. 9 shows a conventional municipal wastewater flow diagram; and

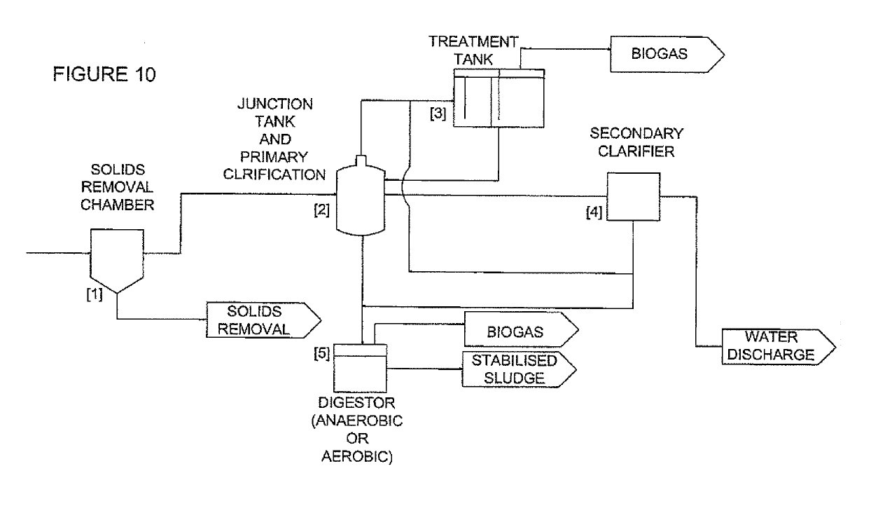

FIG. 10 shows a municipal wastewater flow arrangement according to the present invention.

### THE PRIOR ART PROCESS

The patent applied prior art process is typified by the following outline and showed further in FIG. 1.

### Stage 1

Water is pumped from a depth within a mine shaft to the inlet of the treatment plant, which can typically be some height above.

### Stage 2

That contaminated water is gravity fed through the plant. Lime is added (sometimes in combination with re-circulated sludge) to raise the pH.

### Stage 3

The output of stage 2 is then mixed in a tank for enough time to allow metals to precipitate out in solution. The liquid is then fed under gravity to a clarification tank. A coagulant such as poly aluminium chloride is added at this stage to allow the solids to reach settlement size.

### Stage 4

Clarification tanks typically operate under gravity with solids settling to the bottom and the treated water discharged to a local water course from the top of the tank under gravity. Solids are taken from the bottom of the tank in the form of sludge and disposed of.

As explained above the drawbacks to the existing process is that due to the nature of gaseous and sludge waste produced along with the size of the plant mean that it has to be located on the surface and large amounts of energy are consumed in pumping water from the mine up to the inlet of the treatment plant. This energy has associated financial and carbon costs.

### DETAILED DESCRIPTION OF THE INVENTION

The new process according to this invention includes all or some of the following stages as numbered in FIG. 2:

### Stage 1

Borehole pumps are used to prime the sealed system, once primed valves allow the siphon or natural head to allow water to bypass the pump, labelled [1].

### Stage 2

A motive force for driving water is fed though plant predominantly by natural siphon or natural static head (‘conducted flow’). Water is mixed with recirculated sludge [2]. The mine water and recirculated sludge mixture is then fed into a junction tank [3]. Excess air is vented from this tank by a mechanical air valve or vacuum pump operating on level control [4]. The vacuum pump allows air to be withdrawn from the system operating under the vacuum pressures present within a siphon and the air vent is used to remove air when operating under positive pressure conditions.

### Stage 3

Water is pumped from junction tank to aeration tanks where aeration mixing and precipitation occur. Water leaving the aeration tanks is returned back to the junction tank. Precipitates leave the junction tank with treated water and are transferred to hydrocyclones for separation of solids from water. The water in the line to the aeration tanks can be dosed with one or more chemicals. A non-exhaustive list is:
i. For pH adjustment one or more of the following: Lime, NaOH, CO₂
ii. For enhanced oxidation: H₂O₂, UV, NaOH
iii. For removal of Sulphate by precipitation: Alum, Gypsum, Lime, One or more Barium compounds: BaS, Ba(OH)₂, BaCO₃ or Coal Fly Ash
iv. For sulphidic precipitation of metals: NaHS, H₂S
v. For coagulation of particles and enhance separation efficiency of precipitated particles: Coagulants available to the water industry such as Poly Aluminium Chloride or FeCl3 or FeSO4 or Lime.

The arrangement above can be repeated in series any number of times (‘n’) as shown in FIG. 5 with chemicals being dosed to meet specific treatment requirements.

Sequential dosing stages can be used to allow for the sequential precipitation of metals at differing pH's and/or metal sulphides under sulphidic conditions. If sequential precipitation is required items [3]-[11] would be the first stage and the same process would be repeated for each pH raise and precipitate separation stage required. NaHS or H₂S may be added to allow precipitation of a sulphidised metal [18]. Some metals require oxidation therefore if aeration provided in aeration tank is insufficient chemical oxidation agents such as H₂O₂ or NaOH may be used. Coagulant may be added to increase particle size for subsequent separation [18]. If total dissolved salt (TDS) levels are high Barium compounds such as Ba(OH)₂ or BaS or Fly Ash, or further lime can be dosed to remove sulphates and some Sodium (Na). The chemistry for these sulphate removal options are given in the following papers incorporated in this description:
i. A REVIEW OF SULFATE REMOVAL OPTIONS FOR MINE WATERS; by R. J. Bowell, SRK Consulting, Windsor Court, 1 Windsor Place, Cardiff CF10 3BX, Wales.
ii. ROLE OF PH ON SULPHATE REMOVAL FROM CIRCUMNEUTRAL MINE WATER USING COAL FLY ASH; by G. Madzivire, L. F. Petrik, W. M. Gitari, G. Balfour, V. R. K. Vadapalli, and T. V. Ojumu.
iii. INTEGRATING SULFIDIZATION WITH NEUTRALIZATION TREATMENT FOR SELECTIVE RECOVERY OF COPPER AND ZINC OVER IRON FROM ACID MINE DRAINAGE; by Li Pang Wang, Josiane Ponou, Seiji Matsuo, Katsunori Okaya, Gjergj Dodbiba, Tatsuki Nazuka, and Toyohisa Fujita

### Stage 4

Water to be treated in tank [7] may be pre-heated by using a heat exchanger coupled to a secondary fluid which is heated by a heat pump, which operates to concentrate heat from a heat collection array located in the mine water body at depth. This arrangement allows the fluid in the collection array to provide fluid to the heat pump at minewater temperature (circa 10-20° C.), the heat pump concentrates this to a temperature suitable for the secondary fluid to drive heat exchange on the inlet to the aeration tank (circa 30-60° C.), the feed to the aeration tank is then heated from circa 10° C. to circa 30-40° C. Preheating step heats the flow of water so that the tanks are kept at a temperature suitable for microbial treatment.

When this additional microbial treatment is required the relevant tanks are also fitted with a bed of either tubular or pall ring media [17] to enable suitable concentrations of microbial growth. The media provides a base for ‘fixed’ biomass growth. Media is retained in tank by a mesh support at top and bottom, this media is shown in FIG. 4. Biological media growth may be used for reduction of metals or increased rates of oxidation of metals within the aeration tank.

### Stage 5

The improved aeration tank uses bubble diffusers which can be sized so that the air bubble size and contact time in the top section of the tank ensures that effective aeration takes place and so that the mixing provided by the bubbles also replaces mechanical mixing of conventional treatment process reducing the process energy requirement. The arrangement is such that the air and water flow counter current to one another and is located above a precipitation section. Precipitated particles settle toward the bottom section of the tank and air bubbles are allowed to separate from the water. Water continuously flows down out of the bottom of the tank entraining precipitated particles. This arrangement uses the kinetic energy of the water leaving the tank to eliminate the need for mechanical scraping as employed in conventional HDS processes. The aeration tank arrangement is shown in FIG. 4.

Recycle rate within the loop [3]-[7]-[3] is controlled to allow enough contact time to allow coagulation of precipitants and aeration of the mixture. The flow rate to and from the aeration stage is controlled so that the main siphon flow is not broken.

Aeration to the tanks if required underground is provided by a fan [8] which takes air from the mine and a proportion of exhaust air. Excess air is vented to the surface or a safe exhaust point using duct work and fan [9]. The system is shown located in mine in FIG. 3.

### Stage 6

Treated water leaves tank [3] where it is pumped by the compensation pump [10] which acts to maintain a target flow (which can be changed to meet operating conditions) and provide the pressure drop required through ‘n’ banks of scalable flow rate hydrocyclone bank(s) [11]. If a sludge detwatering process is used, excess water from this sub process can also be returned to the inlet of the compensation pump [10]. A detail showing a typical arrangement of n banks of separation devices is shown in FIG. 7.

### Stage 7

Sludges are removed from the base of the hydrocyclones and then dewatered using a screw press or belt filtration dependent upon requirements [12], excess water from this stage is fed back to the suction of the compensation pump [10]. Sludge from the process is mixed with a cementatious stabiliser [13] to a concentration that allows the sludge to be physically and environmentally stable i.e. Contaminants within the sludge can only leach at a regulatory acceptable level to be left in the mine. The sludge stabilisation process is shown in FIG. 6.

### Stage 8

Water is discharged via a sealed pipework manifold connecting all hydrocyclones to a low point. This point may be within the mine or be a discharge point ultimately feeding into another water body [14]. (The lower the level of the receiving point the greater the effect of the siphon across the plant and the greater the saving). A sealed treated water tank [15] may also be present before the discharge point to allow water to be sampled for quality before discharge.

### Stage 9

A heat exchange device [16] may be located after the hydrocyclones and before the discharge point or treated water tank to remove heat from the main siphon stream. The heat removed via the heat exchange device would heat a separate closed stream which would be used to transfer the heat to the point at which it was needed. The use of a heat exchange device would as well as providing a low carbon heat source also prevent discharge of mine water at temperatures too high for the receiving water course.

The process of the present invention as applied to municipal or industrial water treatment may include all or some of the following stages as numbered in FIG. 8:

### Stage 1

An optional sealed tank [21] provides a feed source for the process and enables the supply head (h1) available from collection network to be utilised by the process of the present invention as a driving force as well as the discharge head (h2). Pump [1] primes the sealed system, once primed valves allow the siphon or natural head to allow water to bypass this pump. A mechanical device such as a grit mesh or screw pump [22] is used to remove heavy solids from this tank.

### Stage 2

A motive force for driving water is fed though plant predominantly by natural siphon or natural static head (‘conducted flow’). Water can be mixed with recirculated sludges and/or chemicals [2]. The water in the line can be dosed with chemicals at pt 1 or pt 2 can be used to aid treatment as defined by project. A non-exhaustive list is:
vi. pH adjustment chemicals: Lime, NaOH, CO₂
vii. For enhanced oxidation: H₂O₂, NaOH
viii. For removal of Sulphate by precipitation: Alum, Gypsum, Lime, One or more Barium compounds: BaS, Ba(OH)₂, BaCO₃ or Coal Fly Ash
ix. For sulphidic precipitation of metals: NaHS, H₂S
x. For coagulation of particles and enhance separation efficiency of precipitated particles: Coagulants available to the water industry such as Poly Aluminium Chloride or FeCl3 or FeSO4 or Lime.
xi. Commercially available flocculants
xii. Adsorbents
xiii. Other water treatment chemicals

The water and if relevant, recirculated sludge mixture is then fed into a junction tank [3]. Excess gas or biogas is vented from this tank by a mechanical air valve or vacuum pump operating on level control [4]. The vacuum pump allows gases to be withdrawn from the system operating under the vacuum pressures present within a siphon and the air vent is used to remove gases such when operating under positive pressure conditions.

### Stage 3

Water is pumped from junction tank either to (n) standard water treatment unit operation tanks [7]. Unit operations that could be included are given below:
1. Rotating biological contactor
2. Submerged aeration filter
3. Electrostatic precipitation
4. Ion exchange
5. Adsorption media filtration
6. Physical media filtration
7. Chemical precipitation
8. Froth flotation
9. Chlorination
10. Dechlorination
11. Aeration
12. Anaerobic digestion
13. Mixing
14. Oxidation by any of UV, Ozone

Water and if required sludge leaving the water treatment tanks is returned back to the junction tank via line [20]. If chemicals are separated within the unit operation these can be withdrawn from a separate point on [7] to separation device [19] which allows water to be recycled for further treatment and highly concentrated chemicals or solids to be discharged.

The unit operations can be operated as open topped vessels or as closed vessels allowing operating at the same pressure as the sealed system and so reducing the energy consumed by pump [5]. If the vessels are operated sealed this also allows the recovery of gases produced e.g. H₂S, CH₄, CO₂.

### Stage 4

Precipitates and chemicals returned to the junction tank [3] these then flow with compensation pump [10] assistance which acts to maintain a target flow (which can be changed to meet operating conditions) and if required supplement system pressure to provide the pressure drop required through ‘n’ banks of any of the water treatment unit operations listed above and/or any of the standard separation devices listed below, all located at [11]:
1. Hydrocyclones
2. Clarifiers
3. Tilted plate separation
4. Sedimentation

The arrangement in stages 3 and 4 above can be repeated in series any number of times (‘n’) as shown in FIG. 5 with chemicals being dosed to meet specific treatment requirements.

### Stage 5

Water to be treated in tank [7] may be pre-heated by using a heat exchanger coupled to a secondary fluid which is heated by a heat pump, which operates to concentrate heat from a heat collection array located in the feed water. This arrangement allows the fluid in the collection array to provide fluid to the heat pump at minewater temperature (circa 10-20° C.), the heat pump concentrates this to a temperature suitable for the secondary fluid to drive heat exchange on the inlet to the aeration tank (circa 30-60° C.), the feed to the aeration tank is then heated from circa 10° C. to circa 30-40° C. Preheating step heats the flow of water so that the tanks are kept at a temperature suitable for microbial treatment.

### Stage 6

The improved aeration tank uses bubble diffusers which can be sized so that the air bubble size and contact time in the top section of the tank ensures that effective aeration takes place and so that the mixing provided by the bubbles also replaces mechanical mixing of conventional treatment process reducing the process energy requirement. The arrangement is such that the air and water flow counter current to one another and is located above a precipitation section. Precipitated particles settle toward the bottom section of the tank and air bubbles are allowed to separate from the water. Water continuously flows down out of the bottom of the tank entraining precipitated particles. This arrangement uses the kinetic energy of the water leaving the tank to eliminate the need for mechanical scraping as employed in conventional processes. The aeration tank arrangement is shown in FIG. 4.

Recycle rate within the loop [3]-[7]-[3] is controlled to allow enough contact time to allow coagulation of precipitants and aeration of the mixture.

The flow rate to and from the aeration stage is controlled so that the main siphon flow is not broken.

Aeration to the tanks if required underground is provided by a fan [8] or vacuum pump [9].

### Stage 7

If a sludge dewatering process is used, excess water from this sub process can also be returned to the inlet of the compensation pump [10]. A detail showing a typical arrangement of n banks of separation devices is shown in FIG. 7.

### Stage 8

Sludges are removed from the base of the separation devices and then dewatered using a screw press or belt filtration dependent upon requirements [12], excess water from this stage is fed back to the suction of the compensation pump [10]. Sludge from the process can be mixed with a cementatious stabiliser [13] to a concentration that allows the sludge to be physically and environmentally stable i.e. Contaminants within the sludge can only leach at a regulatory acceptable level. The sludge stabilisation process is shown in FIG. 6.

### Stage 9

Water is discharged via a sealed pipework manifold connecting all in line water treatment or separation devices to a low point. This point is at a level below the inlet [14]. (The lower the level of the receiving point the greater the effect of the siphon across the plant and the greater the saving). A sealed treated water tank [15] may also be present before the discharge point to allow water to be sampled for quality before discharge.

### Stage 10

A heat exchange device [16] may be located after the separation devices and before the discharge point or treated water tank to remove heat from the main siphon stream. The heat removed via the heat exchange device would heat a separate closed stream which would be used to transfer the heat to the point at which it was needed. The use of a heat exchange device would as well as providing a low carbon heat source also prevent discharge of mine water at temperatures too high for the receiving water course.

### Application

The above system is envisaged to have utility in a multitude of areas including:
i. Surface mine/quarry drainage treatment
   The system is of lower capital and operational cost and can be utilised to treat mine drainage at the surface more cost effectively than prior art systems.
ii. Subsurface ‘In mine’ drainage treatment
   The system is of lower capital and operational cost and can be utilised to treat mine drainage within a mine which is not currently economically feasible utilising the prior art systems.
iii. Co-recovery of metals with water treatment.
   The system can be used to treat water and recover metals which are present in the water.
iv. Removal of sulphates from waters.
v. Integration of biological processes into minewater treatment to enhance rates of treatment.
vi. The energy efficient treatment of municipal wastewater. The system is of lower capital and operational cost and can be utilised to treat water more cost effectively than prior art systems.
vii. The treatment of industrial wastewater. The system is of lower capital and operational cost and can be utilised to treat water more cost effectively than prior art systems.
viii. The pH correction of drinking water
ix. The treatment of leachate. The system is of lower capital and operational cost and can be utilised to treat water more cost effectively than prior art systems.
x. The recovery of gases during treatment this will allow toxic gases e.g. H2S to be recovered and treated or greenhouse gases such as Biogas with CH₄ or CO₂ to be recovered and stored or burnt during treatment.
xi. The process will allow the improved treatment of waters which require anaerobic treatment with recovery of gases. The conventional wastewater flow diagram is showing in FIG. 9. Solids enter an open grit removal chamber [1] and then undergo open tanked clarification [2] before sludge is en to a digester [5], these initial steps allow wastewater to be oxidised prior to being fed to digestion, this is unwanted if anaerobic digestion is required. FIG. 10 shows a wastewater flow arrangement according to the present invention, where the sealed stages at [1] and sealed junction and clarification tank [2] allow the wastewater to remain in an anaerobic state before primary clarification. This process also allows the available head to displace pumping costs and gases to be recovered from the treatment tank [3] if suitable.

1.-37. (canceled)

38. A method for dosing and adjusting the pH of mine water to allow the precipitation of contaminants, comprising the steps of:
providing a principal method for mine water abstraction and discharge to an external water course after treatment by use of one of a siphon and by entry with a head of water flow;
providing an aeration tank that does not involve physical mixing means in said method for mine water abstraction; and
mixing within said aeration tank using a counter current gas/liquid arrangement.
